(19) United States
(12) Patent Application Publication
(10) Pub. No.: US 2025/0208893 A1
(43) Pub. Date: Jun. 26, 2025

(54) SECURE EXECUTION OF CONTAINERS

(71) Applicant: Dell Products L.P., Round Rock, TX (US)

(72) Inventors: Tianxiang Chen, Shanghai (CN); Jinpeng Liu, Shanghai (CN); Zhen Jia, Shanghai (CN); Sarah Evans, Parker, CO (US)

(21) Appl. No.: 18/396,401

(22) Filed: Dec. 26, 2023

(51) Int. Cl. G06F 9/455

(52) U.S. Cl. CPC G06F 9/45558; G06F 9/45545; G06F 2009/45587

(57) ABSTRACT

Methods, apparatus, and processor-readable storage media for securely executing containers are provided herein. An example computer-implemented method includes, in response to a request to start a container in a container-based environment, where the request initiates an execution of a container startup process in a kernel space of an operating system, generating a set of data corresponding to a sequence of components to be used to start the container in the container-based environment. The method also includes comparing the generated set of data to a set of trusted data for the sequence of components and automatically controlling a start of the container based at least in part on a result of the comparing.

### BACKGROUND

Information processing systems increasingly utilize reconfigurable virtual resources to meet changing user needs in an efficient, flexible, and cost-effective manner. For example, cloud-based computing and storage systems implemented using virtual resources in the form of containers have been widely adopted.

### SUMMARY

Illustrative embodiments of the disclosure provide techniques for securely executing containers. An exemplary computer-implemented method includes, in response to a request to start a container in a container-based environment, where the request initiates an execution of a container startup process in a kernel space of an operating system, generating a set of data corresponding to a sequence of components to be used to start the container in the container-based environment. The method also includes comparing the generated set of data to a set of trusted data for the sequence of components and automatically controlling a start of the container based at least in part on a result of the comparing.

Illustrative embodiments can provide significant advantages relative to conventional container security techniques. For example, technical problems associated with protecting against malware attacks in container-based environments are mitigated in one or more embodiments by verifying a sequence of components used for starting a container in a container-based environment prior to executing the container.

These and other illustrative embodiments described herein include, without limitation, methods, apparatus, systems, and computer program products comprising processor-readable storage media.

### BRIEF DESCRIPTION OF THE DRAWINGS

FIG. 1 depicts an example of a container orchestration environment in an illustrative embodiment.

FIG. 2 depicts an information processing system within which the container orchestration environment of FIG. 1 can be implemented in an illustrative embodiment.

FIG. 3 illustrates an example of a type of attack that can be protected against in accordance with illustrative embodiments.

FIG. 4 shows an example architecture of a host device in an illustrative embodiment.

FIG. 5 illustrates a process flow diagram for verifying containers in an illustrative embodiment.

FIG. 6 shows a flow diagram of a process for securely executing containers in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As the term is illustratively used herein, a container may be considered lightweight, stand-alone, executable software code that includes elements needed to execute the software code. A container-based structure has many advantages including, but not limited to, isolating the software code from its surroundings, and helping reduce conflicts between different tenants or users running different software code on the same underlying infrastructure. The term “user” herein is intended to be broadly construed so as to encompass numerous arrangements of human, hardware, software or firmware entities, as well as combinations of such entities.

Containers may be implemented using a container orchestration system (e.g., a Kubernetes container orchestration system). Container orchestration systems can provide functionality for automating application deployment, scaling, and management within a container-based information processing system comprised of components referred to as pods, nodes, and clusters.

Multiple types of containers can be implemented or otherwise adapted to such container-based orchestration systems, including Docker containers and/or other types of Linux containers (LXCs), as non-limiting examples. Container orchestration systems are rapidly being adopted by many enterprise-based information technology (IT) organizations to deploy their application programs (applications). By way of example only, such applications may include stateless (or inherently redundant applications) and/or stateful applications. Non-limiting examples of stateful applications may include legacy databases, as well as other stateful applications that are not inherently redundant. Although examples of container orchestration systems are used to illustrate various embodiments, it is to be understood that alternative container orchestration systems can be utilized.

A container-based environment generally can include one or more containers that are part of a pod. Thus, the environment may be referred to, more generally, as a pod-based system, a pod-based container system, a pod-based container orchestration system, a pod-based container management system, or the like. A pod is generally considered to be the smallest execution unit in a container orchestration environment. A pod encapsulates one or more containers, and one or more pods can be executed on a worker node. Multiple worker nodes form a cluster. A cluster is managed by at least one manager node. Such a container-based environment may include multiple clusters respectively managed by multiple manager nodes. Furthermore, pods typically represent the respective processes running on a cluster. A pod may be configured as a single process wherein one or more containers execute one or more functions that operate together to implement the process. Pods may each have a unique Internet Protocol (IP) address enabling pods to communicate with one another, and for other system components to communicate with each pod. Also, pods may each have persistent storage volumes associated therewith. Configuration information (e.g., configuration objects) indicating how a container executes can be specified for each pod.

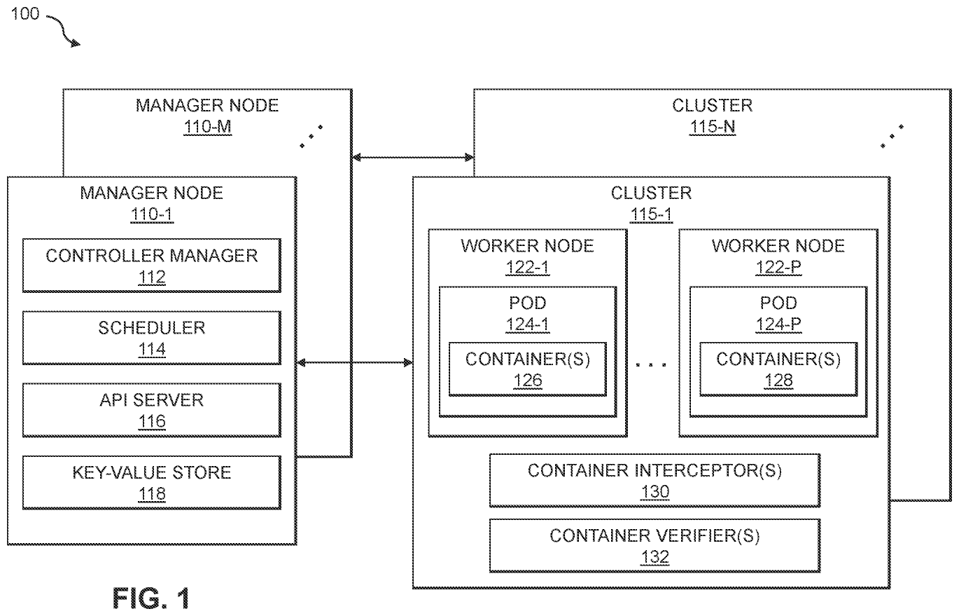

FIG. 1 depicts an example of a container orchestration environment 100 in an illustrative embodiment. In the example shown in FIG. 1, a plurality of manager nodes 110-1, . . . 110-M (herein each individually referred to as a manager node 110 or collectively as manager nodes 110) are operatively coupled to a plurality of clusters 115-1, . . . 115-N (herein each individually referred to as a cluster 115 or collectively as clusters 115). As mentioned above, each cluster 115 is managed by at least one manager node 110.

Each cluster 115 comprises a plurality of worker nodes 122-1, . . . 122-P (herein each individually referred to as a worker node 122 or collectively as worker nodes 122), one or more container interceptors 130, and one or more container verifiers 132. Each worker node 122 comprises a respective pod, i.e., one of a plurality of pods 124-1, . . . 124-P (herein each individually referred to as a pod 124 or collectively as pods 124). However, it is to be understood that one or more worker nodes 122 can execute multiple pods 124 at a time. Each pod 124 comprises a set of containers (e.g., containers 126 and 128). It is noted that each pod 124 may also have a different number of containers. As used herein, a pod may be referred to more generally as a containerized workload. One example of a containerized workload is an application program configured to provide a microservice. A microservice architecture is a software approach wherein a single application is composed of a plurality of loosely-coupled and independently-deployable smaller components or services.

Generally, the one or more container interceptors 130 are configured to intercept requests for starting one or more of the containers 126 and/or 128. In response to intercepting a request for a given one of the containers 126 and/or 128, a corresponding one of the container verifiers 132 is configured to verify the given container. The container verifier 132 can prevent or allow the container from starting and/or executing based on a result of the verification, as described in more detail elsewhere herein.

As also shown in FIG. 1, each manager node 110 comprises a controller manager 112, a scheduler 114, an application programming interface (API) server 116, and a key-value store 118. It is to be appreciated that in some embodiments, multiple manager nodes 110 may share one or more of the same controller manager 112, the same scheduler 114, the same API server 116, and/or the same key-value store 118.

Worker nodes 122 of each cluster 115 execute one or more applications associated with pods 124 (e.g., containerized workloads). In some embodiments, each manager node 110 can manage the worker nodes 122, and therefore pods 124 and containers, in its corresponding cluster 115. In general, controller manager 112 executes control processes (e.g., controllers) that are used to manage operations, for example, in the worker nodes 122. Scheduler 114 typically schedules pods to execute on particular worker nodes 122 taking into account node resources and application execution requirements such as, but not limited to, deadlines. The API server 116 may expose a front end of the container orchestration system. Key-value store 118 typically provides key-value storage for all cluster data including, but not limited to, configuration data objects generated, modified, deleted, and/or otherwise managed, during the course of system operations.

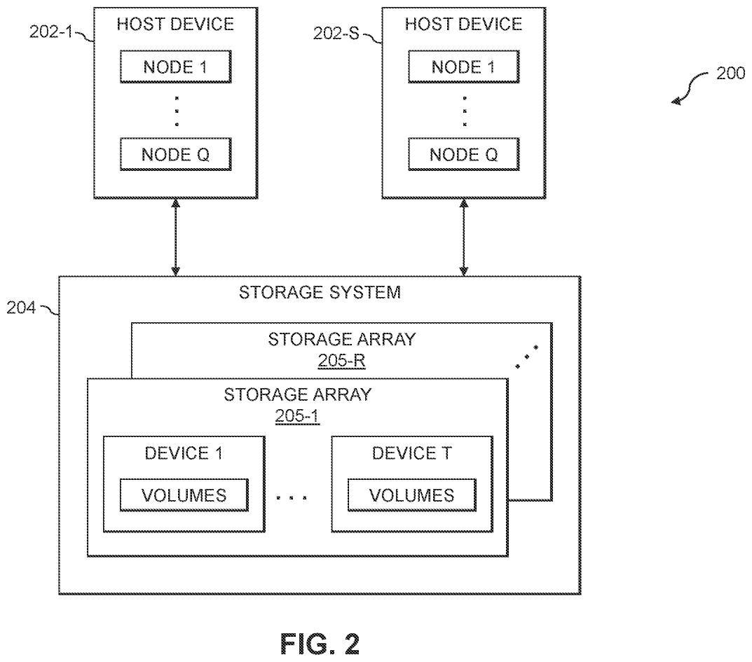

Turning now to FIG. 2, an information processing system 200 is depicted within which the container orchestration environment 100 of FIG. 1 can be implemented. More particularly, as shown in FIG. 2, a plurality of host devices 202-1, . . . 202-S (herein each individually referred to as a host device 202 or collectively as host devices 202) are operatively coupled to a storage system 204. Each host device 202 hosts a set of nodes 1, . . . . Q. Note that while multiple nodes are illustrated on each host device 202, a host device 202 can host a single node, and one or more host devices 202 can host a different number of nodes as compared with one or more other host devices 202.

As further shown in FIG. 2, storage system 204 comprises a plurality of storage arrays 205-1, . . . 205-R (herein each individually referred to as a storage array 205 or collectively as storage arrays 205), each of which is comprised of a set of storage devices 1, . . . . T upon which one or more storage volumes are persisted. The storage volumes depicted in the storage devices of each storage array 205 can include any data generated in the information processing system 200 but, more typically, include data generated, manipulated, or otherwise accessed, during the execution of one or more applications in the nodes of host devices 202. One or more storage arrays 205 may comprise a different number of storage devices as compared with one or more other storage arrays 205.

Furthermore, any one of nodes 1, . . . . Q on a given host device 202 can be a manager node 110 or a worker node 122 (FIG. 1). In some embodiments, a node can be configured as a manager node for one execution environment and as a worker node for another execution environment. Thus, the components of container orchestration environment 100 in FIG. 1 can be implemented on one or more of host devices 202, such that data associated with pods 124 (FIG. 1) running on the nodes 1, . . . . Q is stored as persistent storage volumes in one or more of the storage devices 1, . . . . T of one or more of storage arrays 205.

Host devices 202 and storage system 204 of information processing system 200 are assumed to be implemented using at least one processing platform comprising one or more processing devices each having a processor coupled to a memory. Such processing devices can illustratively include particular arrangements of compute, storage, and network resources. In some alternative embodiments, one or more host devices 202 and storage system 204 can be implemented on respective distinct processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of information processing system 200 are possible, in which certain components of the system reside in one data center in a first geographic location while other components of the system reside in one or more other data centers in one or more other geographic locations that are potentially remote from the first geographic location. Thus, it is possible in some implementations of information processing system 200 for portions or components thereof to reside in different data centers. Numerous other distributed implementations of information processing system 200 are possible. Accordingly, the constituent parts of information processing system 200 can also be implemented in a distributed manner across multiple computing platforms.

Additional examples of processing platforms utilized to implement containers, container environments, and container management systems in illustrative embodiments, such as those depicted in FIGS. 1 and 2, will be described in more detail below in conjunction with additional figures. It is to be appreciated that these and other features of illustrative embodiments are presented by way of example only, and should not be construed as limiting in any way.

Accordingly, different numbers, types and arrangements of system components can be used in other embodiments. Although FIG. 2 shows an arrangement wherein host devices 202 are coupled to just one plurality of storage arrays 205, in other embodiments, host devices 202 may be coupled to and configured for operation with storage arrays across multiple storage systems similar to storage system 204. The functionality associated with the elements 112, 114, 116, and/or 118 in other embodiments can also be combined into a single module, or separated across a larger number of modules. The functionality associated with the elements 130 and/or 132 in other embodiments can also be combined into a single module, or separated across a larger number of modules. In some embodiments, the functionality associated with the elements 130 and/or 132 can be implemented at least in part on one or more of the manager nodes 110. As another example, multiple distinct processors can be used to implement different ones of the elements 112, 114, 116, 118, 130, and/or 132, or portions thereof.

At least portions of elements 112, 114, 116, 118, 130, and/or 132 may be implemented at least in part in the form of software that is stored in memory and executed by a processor.

It should be understood that the particular sets of components implemented in information processing system 200 as illustrated in FIG. 2 are presented by way of example only. In other embodiments, only subsets of these components, or additional or alternative sets of components, may be used, and such components may exhibit alternative functionality and configurations. Additional examples of systems implementing container management functionality will be described below.

Still further, information processing system 200 may be part of a public cloud infrastructure. The cloud infrastructure may also include one or more private clouds and/or one or more hybrid clouds (e.g., a hybrid cloud is a combination of one or more private clouds and one or more public clouds).

Container-based environments have changed the way development and operations teams test and deploy modern software. Containers help companies modernize by making it easier to scale and deploy applications. The pod brings the containers together and makes it easier to scale and deploy applications. Clusters allow containers to execute across multiple machines and environments: such as virtual, physical, cloud-based, and on-premises environments. As shown and described above in the context of FIG. 1, clusters are generally comprised of one manager node and one or more worker nodes. These nodes can be physical computers or virtual machines (VMs), depending on the cluster. Typically, a given cluster is allocated a fixed number of resources (e.g., central processing unit (CPU), memory, and/or other computer resources), and when a container is defined, the number of resources from among the resources allocated to the cluster is specified. When the container starts executing, pods are created on the deployed container that will serve the incoming requests.

Some container-based environments enable a multi-cluster environment by sharing and abstracting the underlying compute, network, and storage physical infrastructure, e.g., as illustrated and described above in the context of FIG. 2. With shared compute/storage/network resources, the nodes are enabled and added to the cluster. The pod network allows identification of the pod across the network. With this cluster, a pod can execute in any node and scale based on a replica set.

The number of pods needed to execute for the cluster can be defined using the replica set. When the container loads, the defined number of pods will be loaded for that service. A larger number of pods means a larger resource allocation. The amount of memory and CPU that the container can use for a cluster and a pod can also be defined. If the load of a container in a given cluster increases, then the container generally will continue to spin (e.g., add) additional pods to support the increased load.

Conventional techniques for securing containers generally include security scanning tools, securing communications associated with containers, and/or securing sensitive data, as well as using one or more of namespaces, control groups, mandatory access control (MAC), and/or secure computing modes. Such techniques can protect data in storage and/or data in transit, but do not protect against attacks from a kernel of an operating system for data in use.

It is noted that the term “kernel space” as used herein is intended to be broadly construed, so as to encompass, for example, a portion of memory where the kernel of the operating system resides and executes. The kernel space, in some examples, can be used to manage network and other hardware interactions with devices and drivers. Accordingly, the kernel space may include core components of the operating system, such as a device manager (e.g., udev), a network layer, a filesystem, and a hardware abstraction layer (HAL). It is to be appreciated that the device manager may manage device nodes and user space events raised when hardware devices are added or removed from the system, including firmware loading as required by certain devices. The HAL can be implemented to communicate with the network layer for communication related to usage data, for example. When code is executed in the kernel space, a processor can operate in a privileged mode, which can provide unrestricted access to system resources (e.g., memory, hardware peripherals, processor instructions, and control settings).

The term “user space” as used herein is intended to be broadly construed, so as to encompass, for example, a portion of memory where user-level applications and programs can execute. When code runs in the user space, the processor generally operates in a non-privileged or restricted mode, which prevents user-space programs from having direct access to the hardware or designated system resources (e.g., critical system resources).

In at least some embodiments, a given host device (e.g., host device 202-1) may execute a container engine (e.g., a Docker engine). The container engine, in some embodiments, is assumed to comprise multiple components including, for example, a container client, a container object management component (e.g., Docker daemon), a container lifecycle management component (e.g., containerd), a decoupling component (e.g., shim), a runtime component (e.g., runc), and one or more running containers.

The container client, in some embodiments, comprises a terminal and/or console that enables an end user to interact with the container engine via one or more APIs. The container object management component may provide functionality for managing container objects such as container images, containers, networks, and/or volumes (e.g., based on messages received via the APIs). The container lifecycle management component, for example, can function as a bridge between the container object management component and the runtime component. As an example, the container object management component can manage container lifecycle operations, such as starting containers, stopping containers, pausing containers, un-pausing containers, and/or destroying containers. According to some embodiments, the decoupling component can comprise a kernel component that decouples the running containers from the container object management component such that running containers do not need to be restarted if the container object management component is restarted (e.g., due to a version update). The runtime component is used to create containers inside the kernel of the operating system. The running containers may include respective process images registered with the kernel of the operating system. A given process image may include a process context table, memory regions, input/output table, and/or other information related to the running container, as non-limiting examples.

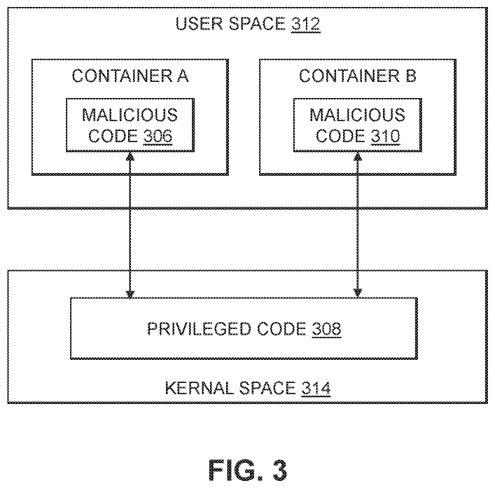

FIG. 3 illustrates an example of a type of attack that can be protected against in accordance with illustrative embodiments. The example shown in FIG. 3 depicts two containers (container A and container B) implemented in a user space 312 of an operating system of a host device, and privileged code 308 implemented in a kernel space 314 of the operating system. The privileged code may include container runtime code or code related to a decoupling component, as non-limiting examples. In the FIG. 3 example, it is assumed that container A comprises malicious code 306 that is used to initiate an attack on the privileged code 308 (e.g., by injecting code into its container runtime code). Accordingly, the container runtime for container A can then infect the container runtime for container B in the privileged code 308. This in turn infects container B with malicious code 310. The malicious code 310, for example, may be configured to obtain data (possibly sensitive data) from container B. Protecting against these types of attacks is often challenging because the attack is conducted using the kernel space 314 of the operating system, and thus generally has unrestricted access to the system resources.

In some embodiments, a given host device can implement a trusted boot process that is designed to prevent unauthorized or modified code from running when the host device is booting up. For example, a secure boot process can verify a sequence of digital signatures (also referred to as a chain of trust). As an example, the trusted boot process can verify a digital signature of firmware to reduce the risk of firmware rootkit attacks, and then a digital signature of a bootloader of the operating system can be verified for all code that is loaded prior to the operating system starting. The trusted boot process can then verify digital signatures of a kernel and boot devices, which can include, startup processes, boot drivers, and/or startup files as non-limiting examples.

Some trusted boot processes can utilize a particular hardware component, such as a trusted platform module (TPM). A TPM generally includes a microcontroller designed to secure hardware and serves as the root of trust of a given platform. The TPM can securely store cryptographic key material and platform measurements to help ensure that the platform remains trustworthy. In at least some examples, hash codes (e.g., hash values) of binaries can be extended into platform configuration registers (PCRs) corresponding to the TPM. As an example, hash codes can be generated by concatenating previous content of the PCR with an input hash code, and the result can then be stored in the PCR. Hardware-based cryptography can help ensure that the information stored in the TPM is better protected relative to software-preserved data.

One or more embodiments described herein can extend the chain of trust process when a new container is started in a container-based environment. Such embodiments can utilize a software mechanism that hooks into the operating system kernel so that a chain of components corresponding to a new container can be verified. The software mechanism, in some embodiments, may be implemented using a Berkeley Packet Filter (BPF) and a user space software tool (e.g., an extended BPF (eBPF) tool) that provides a kernel extension framework by injecting hooks and/or processes into the kernel API. As a non-limiting example, a BPF can be started as a network filter in a data-network packet analyzer computer program that runs under a command line interface, such as tcpdump. The eBPF client can correspond to a toolkit that provides functionality to dynamically inject processes and/or hooks into the operating system kernel API from the user space, without recompiling or restarting the operating system kernel.

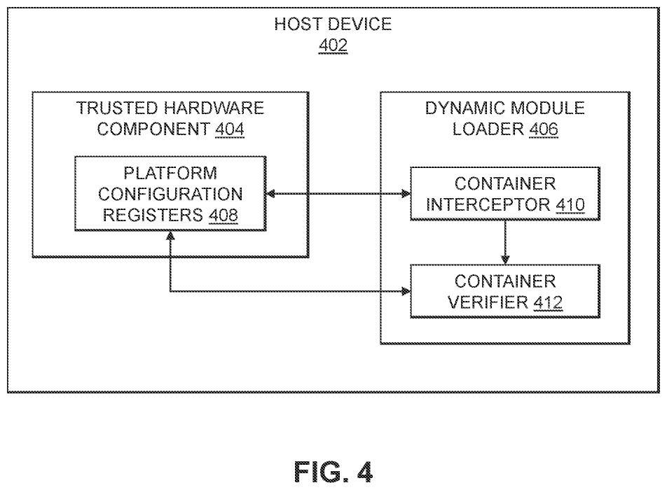

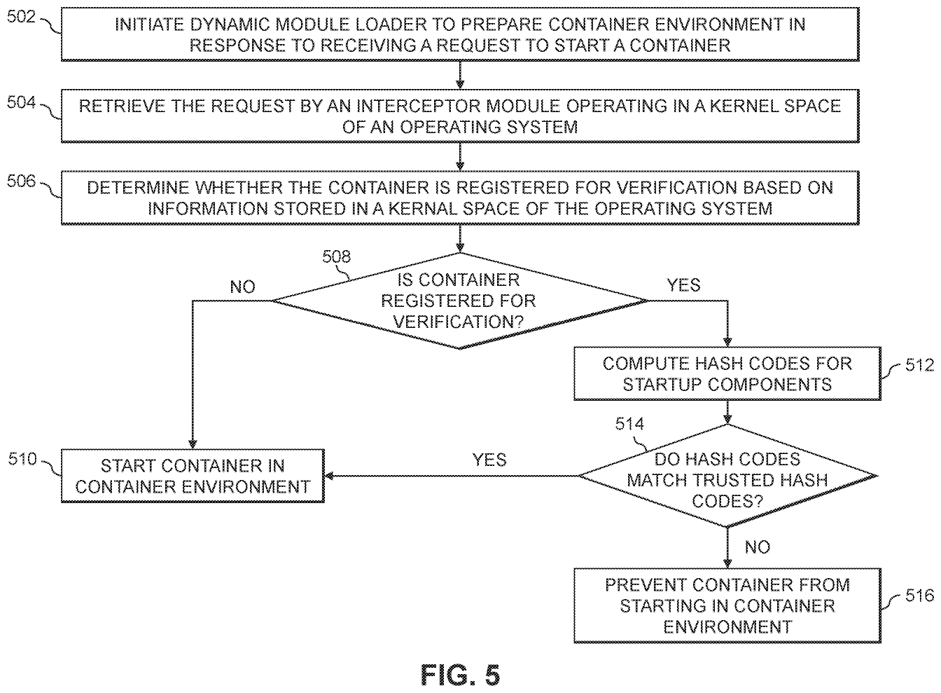

According to some embodiments, the eBPF client can be used to hook an open function and a read function into the kernel space of the operating system. The open function can be used to check if a container (e.g., via some identifier, such as a filename) is registered with the verification service. If a container is registered, then the read function can include functionality for calculating the hash code of each loaded module and comparing the calculated hash code against trusted hash codes stored in a PCR, as explained in more detail in conjunction with FIGS. 4-5, for example.

FIG. 4 shows an example architecture of a host device 402 in an illustrative embodiment. The host device 402 can correspond to given one of the host devices 202, for example. In the FIG. 4 example, the host device 402 includes a trusted hardware component 404 (e.g., a TPM), and a dynamic module loader 406. The dynamic module loader 406, in some embodiments, can correspond to a kernel dynamic module loader. The dynamic module loader 406 also includes a container interceptor 410 and a container verifier 412, which in some examples can correspond respectively to a container interceptor 130 and a container verifier 132. The container interceptor 410 can intercept a request to start a container service. As a non-limiting example, a request for a new container service can be obtained from a container client interface of the host device 402, and a job to start the container service can be sent to an object management component, such as a container daemon. The container interceptor 410 obtains the request when the dynamic module loader 406 starts preparing the container environment for the container service. For example, the request can be obtained when the dynamic module loader 406 starts a process to find and load data (e.g., files and/or shared libraries) needed to execute the container service. The container verifier 412 can compute the hash code for each component along the startup chain of the container service. As a non-limiting example, the hash codes for the sequence of components can be computed by the container verifier 412 in the following order: dynamic module loader 406, a container daemon, a container lifecycle management component (e.g., containerd), a decoupling component (e.g., shim), a runtime component (e.g., runc), and an image binary of the container. Accordingly, the container interceptor 410 and the container verifier 412 can inject additional processing into the dynamic module loader 406 for verification of the sequence of components. In some embodiments, the container verifier 412 can prevent the container service from starting if a mismatch is detected.

In at least some embodiments, the hash code for a given component can be computed based on the hash code of the previous module appended with values from the module microcode that is currently being checked. As a non-limiting example, the extended hash code computation for module n using the previous n−1 modules can be represented as follows: Hash(n)=Hash(Hash(n−1)|MAC(n)), where MAC(n) is a mandatory access control (MAC) function of module n. In such embodiments, the computed value extends its length along the verification chain as it appends details of the new component into the computation. The computed hash codes can then be compared with ones stored in platform configuration registers 408 from a previous execution. Successfully verification of the entire chain of components indicates that the components used for starting the container service have not been tampered with, and the service can then be launched.

FIG. 5 illustrates a process flow diagram for verifying containers in an illustrative embodiment. It is to be understood that this particular process is only an example, and additional or alternative processes can be carried out in other embodiments. In this embodiment, the process includes steps 502 through 516. These steps are assumed to be performed at least in part by a container interceptor 410 and a container verifier 412.

Step 502 includes initiating a dynamic module loader to prepare a container environment in response to receiving a request to start a container.

Step 504 includes retrieving the request using an interceptor module operating in a kernel space of an operating system. The interceptor module, in some embodiments, is configured from the user space using an eBPF client, for example.

Step 506 includes determining whether the container is registered for verification based on information stored in a kernel space of the operating system.

Step 508 includes a test that checks if the container is registered for verification. If not, then the process continues to step 510, which includes starting the container in the container environment. If the container is registered for verification, then the process continues to step 512, which includes computing hash codes for the startup components (e.g., a designated set of components). Step 514 includes a test that checks whether the hash codes match trusted hash codes (e.g., stored in a PCR). If one or more of the hash codes do not match the corresponding trusted hash code, then step 516 is performed. Step 516 includes preventing the container from starting in the container environment. If the hash codes match the trusted hash codes, then the container is started at step 510. In at least some examples, at least some of the trusted hash codes can be provided and/or computed by a trusted party (e.g., one or more vendors and/or one or more developers that provide the component).

Step 506 and step 508 provide functionality for allowing certain containers to be verified, while allowing other containers to be started without verification. For example, a user may decide that a given container does not require verification if an application corresponding to the container does not include and/or process sensitive data, which could provide performance improvements, such as reduced start up times. According to some embodiments, the registration process can be performed using an interface implemented in the user space, and a table can be maintained in the kernel space that stores data related to registered containers. The data can include, for example, image names, module names, and/or other identifiers of registered containers. Accordingly, the registration process allows the user to activate and/or deactivate the verification process at step 512 to 516 for individual containers. It is to be appreciated that step 506 and step 508 are optional, and in other embodiments each new container can be verified using steps 512-516.

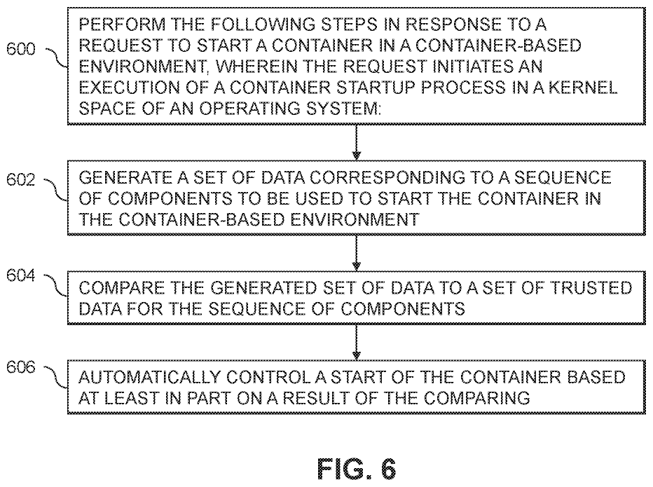

FIG. 6 shows a flow diagram of a process for securely executing containers in an illustrative embodiment. It is to be understood that this particular process is only an example, and additional or alternative processes can be carried out in other embodiments.

In this embodiment, the process includes steps 600 through 606. These steps are assumed to be performed by a container interceptor 130 and a container verifier 132.

Step 600 includes performing steps 602-606 in response to a request to start a container in a container-based environment, wherein the request initiates an execution of a container startup process in a kernel space of an operating system. Step 602 includes generating a set of data corresponding to a sequence of components to be used to start a container in a container-based environment. Step 604 includes comparing the generated set of data to a set of trusted data for the sequence of components. Step 606 includes automatically controlling a start of the container based at least in part on a result of the comparing.

The container startup process may include a dynamic module loader, such as a kernel dynamic loader process. The process can include intercepting the request from the dynamic module loader based at least in part on a software mechanism that injects code into the kernel space from a user space of the operating system. As a non-limiting example, the software mechanism can comprise an eBPF client.

The sequence of components may include two or more of the container startup process, a container object management component, a container lifecycle management component, a bridge component between the container-based environment and the container lifecycle management component that decouples containers running in the container-based environment from the container lifecycle management component, a container runtime component, and at least one software image associated with the container. The set of data may include a first set of hash codes computed for the sequence of components, and the trusted set of data may include a second set of hash codes previously computed for the sequence of components. The set of trusted data may be stored in a secure hardware component of a host device of the operating system. For example, the secure hardware component may include a microcontroller such as a TPM. The automatically controlling the start of the container may include preventing the container from starting in response to determining that the set of data is different than the trusted set of data. The set of data corresponding to the sequence of components may be generated in response to determining that a list of registered containers maintained in the kernel space comprises the container.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to help prevent unauthorized or modified code from running in container-based systems by verifying a sequence of components to be used for starting container, and allowing or preventing the container from starting based on the result of the verification. These and other embodiments can effectively overcome problems associated with attacks in container-based environments that are carried out using a kernel of an operating system.

As mentioned previously, at least portions of the container orchestration environment 100 and/or information processing system 200 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of LXC. The containers are execute on virtual machines in a multi-tenant environment, although other arrangements are possible. The containers are utilized to implement a variety of different types of functionalities within the container orchestration environment 100 and/or information processing system 200. For example, containers can be used to implement respective processing devices providing compute and/or storage services of a cloud-based system. Again, containers may be used in combination with other virtualization infrastructure such as virtual machines implemented using a hypervisor.

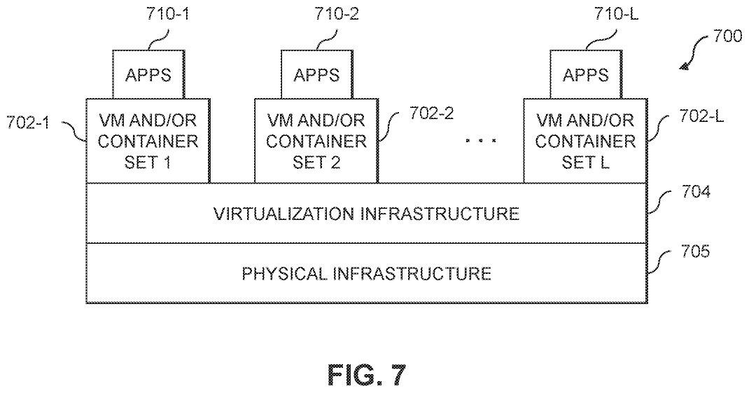

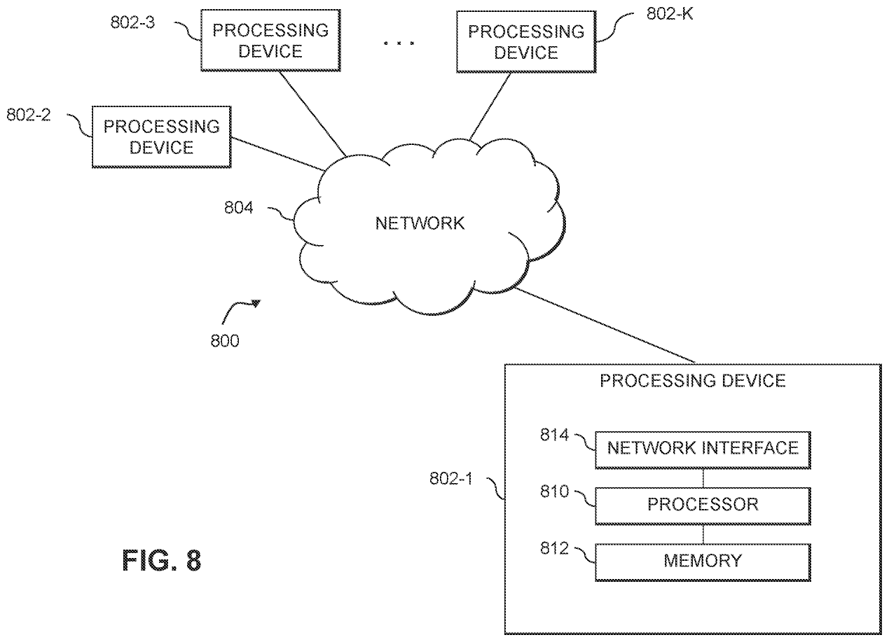

Illustrative embodiments of processing platforms will now be described in greater detail with reference to FIGS. 7 and 8. Although described in the context of container orchestration environment 100 and/or information processing system 200, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the container orchestration environment 100 and/or information processing system 200. The cloud infrastructure 700 comprises multiple VMs and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of container orchestration environment 100 and/or information processing system 200 may each execute on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of container orchestration environment 100 and/or information processing system 200 and includes a plurality of processing devices, denoted 802-1, 802-2, 802-3, . . . 802-K, which communicate with one another over a network 804.

The processing device 802-1 in the processing platform 800 comprises a processor 810 coupled to a memory 812.

The processor 810 processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory 812 comprises random access memory (RAM), read-only memory (ROM) or other types of memory, in any combination. The memory 812 and other memories disclosed herein should be viewed as illustrative examples of what are more generally referred to as “processor-readable storage media” storing executable program code of one or more software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and container orchestration environment 100 and/or information processing system 200 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the container orchestration environment 100 and/or information processing system 200. Such components can communicate with other elements of the container orchestration environment 100 and/or information processing system 200 over any type of network or other communication media.

For example, particular types of storage products that can be used in implementing a given storage system of a distributed processing system in an illustrative embodiment include network-attached storage (NAS), storage area networks (SANs), direct-attached storage (DAS) and distributed DAS, as well as combinations of these and other storage types, including software-defined storage.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
performing the following steps in response to a request to start a container in a container-based environment, wherein the request initiates an execution of a container startup process in a kernel space of an operating system:
generating a set of data corresponding to a sequence of components to be used to start the container in the container-based environment;
comparing the generated set of data to a set of trusted data for the sequence of components; and
automatically controlling a start of the container based at least in part on a result of the comparing;
wherein the method is performed by at least one processing device comprising a processor coupled to a memory.

2. The computer-implemented method of claim 1, wherein the container startup process comprises a dynamic module loader.

3. The computer-implemented method of claim 2, comprising:
intercepting the request from the dynamic module loader based at least in part on a software mechanism that injects code into the kernel space from a user space of the operating system.

4. The computer-implemented method of claim 1, wherein the sequence of components comprises two or more of:
the container startup process;
a container object management component;
a container lifecycle management component;
a bridge component between the container-based environment and the container lifecycle management component that decouples containers running in the container-based environment from the container lifecycle management component;
a container runtime component; and
at least one software image associated with the container.

5. The computer-implemented method of claim 1, wherein:
the set of data comprises a first set of hash codes computed for the sequence of components; and
the trusted set of data comprises a second set of hash codes previously computed for the sequence of components.

6. The computer-implemented method of claim 1, wherein the set of trusted data is stored in a secure hardware component of a host device of the operating system.

7. The computer-implemented method of claim 1, wherein the automatically controlling comprises:
preventing the container from starting in response to determining that the set of data is different than the trusted set of data.

8. The computer-implemented method of claim 1, wherein the set of data corresponding to the sequence of components is generated in response to determining that a list of registered containers maintained in the kernel space comprises the container.

9. A non-transitory processor-readable storage medium having stored therein program code of one or more software programs, wherein the program code when executed by at least one processing device causes the at least one processing device:
in response to a request to start a container in a container-based environment, wherein the request initiates an execution of a container startup process in a kernel space of an operating system:
to generate a set of data corresponding to a sequence of components to be used to start the container in the container-based environment;
to compare the generated set of data to a set of trusted data for the sequence of components; and
to automatically control a start of the container based at least in part on a result of the comparing.

10. The non-transitory processor-readable storage medium of claim 9, wherein the container startup process comprises a dynamic module loader.

11. The non-transitory processor-readable storage medium of claim 10, wherein the program code when executed further causes the at least one processing device:
to intercept the request from the dynamic module loader based at least in part on a software mechanism that injects code into the kernel space from a user space of the operating system.

12. The non-transitory processor-readable storage medium of claim 9, wherein the sequence of components comprises two or more of:
the container startup process;
a container object management component;
a container lifecycle management component;
a bridge component between the container-based environment and the container lifecycle management component that decouples containers running in the container-based environment from the container lifecycle management component;
a container runtime component; and
at least one software image associated with the container.

13. The non-transitory processor-readable storage medium of claim 9, wherein:
the set of data comprises a first set of hash codes computed for the sequence of components; and
the trusted set of data comprises a second set of hash codes previously computed for the sequence of components.

14. The non-transitory processor-readable storage medium of claim 9, wherein the set of trusted data is stored in a secure hardware component of a host device of the operating system.

15. An apparatus comprising:
at least one processing device comprising a processor coupled to a memory;
the at least one processing device being configured:
in response to a request to start a container in a container-based environment, wherein the request initiates an execution of a container startup process in a kernel space of an operating system:
to generate a set of data corresponding to a sequence of components to be used to start the container in the container-based environment;
to compare the generated set of data to a set of trusted data for the sequence of components; and
to automatically control a start of the container based at least in part on a result of the comparing.

16. The apparatus of claim 15, wherein the container startup process comprises a dynamic module loader.

17. The apparatus of claim 16, wherein the at least one processing device is further configured:
to intercept the request from the dynamic module loader based at least in part on a software mechanism that injects code into the kernel space from a user space of the operating system.

18. The apparatus of claim 15, wherein the sequence of components comprises two or more of:
the container startup process;
a container object management component;
a container lifecycle management component;
a bridge component between the container-based environment and the container lifecycle management component that decouples containers running in the container-based environment from the container lifecycle management component;
a container runtime component; and
at least one software image associated with the container.

19. The apparatus of claim 15, wherein:
the set of data comprises a first set of hash codes computed for the sequence of components; and
the trusted set of data comprises a second set of hash codes previously computed for the sequence of components.

20. The apparatus of claim 15, wherein the set of trusted data is stored in a secure hardware component of a host device of the operating system.
